(19) United States
(12) Patent Application Publication
(10) Pub. No.: US 2006/0093859 A1
(43) Pub. Date: May 4, 2006

(54) Hard metal, in particular for cutting stone, concrete, and asphalt

(76) Inventors: Igor Konyashin, Hunfeld (DE); Roy Cooper, Rothenkirchen (DE); Bernd Ries, Hunfeld (DE)

Correspondence Address: GUDRUN E. HUCKETT DRAUDT, LONSSTR. 53, WUPPERTAL, 42289, DE

(21) Appl. No.: 10/517,661

(22) PCT Filed: Jul. 10, 2003
(86) PCT No.: PCT/EP03/07462

§ 371 Date: Dec. 29, 2005

(30) Foreign Application Priority Data
Jul. 10, 2002 (DE) 10231303.2
Oct. 18, 2002 (DE) 10248898.3
Dec. 14, 2002 (DE) 10258537.7

(51) Int. Cl. B32B 5/16; B32B 9/00

(52) U.S. Cl. 428/698; 428/323

(57) ABSTRACT

A hard metal of WC for tools for mechanical working of stone, concrete, and asphalt conatins 5 to 25% by weight of a binder based on Co or Co and Ni. The hard metal has a coercive field strength up to 17.0 kA/m, and the binder contains up to 30% of Fe. The hard metal has a magnetic saturation (σ or 4πσ, in units of microtesla times cubic meter per kilogram, respectively) as a function of the Co proportion (X) in % by weight of the hard metal in a range of σ=0.11 X to σ=0.137 X or 4πσ=0.44 π X to 4πσ=0.548 π X.

The invention relates to a hard metal for tools for mechanical working of, in particular, stone, concrete, and asphalt as well as a tool that is furnished with such a hard metal.

For cutting stone, concrete, and asphalt, coarse grain tungsten carbide-cobalt-hard metals (WC—Co hard metals) having an average WC grain size of approximately 2 to 10 μm are used in practice. The average WC grain size in hard metals can be determined, for example, by the intercepted segment method.

It is understood that the WC hard metals mentioned in this context may comprise any combination and any ratio of tungsten and carbon (carbide). The entirety of these combinations of tungsten carbide is abbreviated by WC in the following description as well as in the claims.

In the hard metal microstructure, relatively thick intermediate layers of Co binders are present between the coarse WC grains. The coercive field strength values of the hard metal indicate how thick the Co intermediate layers are. Normally, the coercive field strength values of the coarse grain hard metals are in the range of up to 17.0 kA/m.

According to the general knowledge in hard metal research (H. Suzuki, H. Kubota, “Planseeberichte Pulvermetallurgie”; 1966, volume 14, 2, pp. 96-109), the carbon contents of hard metals should be approximately in the middle of the two-phase field (without free carbon and η-phase). Based on this, the best values of transverse rupture strength in combination with high hardness are supposed to be obtainable.

In this connection, the concentration of tungsten in the Co binder of the WC—Co hard metal depends on the carbon contents. For example, the tungsten concentration at low carbon contents is significantly higher. The W concentrations and the carbon contents in a WC—Co hard metal with a certain Co contents can be defined by the value of the magnetic saturation. The magnetic saturation of a hard metal (B. Roebuck, “Magnetic Moment (Saturation) Measurements on Hardmetals”, Int. J. Refr. Met. Hard Mater., 14 (1996) 419) is defined as the magnetic moment per unit weight σ (in English: “magnetic moment/unit wt.”) as well as induction of saturation per unit weight 4πσ (in English: “saturation induction/unit wt.”). The magnetic moment must be multiplied by 4π in order to obtain induction of saturation so that the magnetic moment σ of pure Co is 16.1 μTm³/kg and the induction of saturation 4πσ of pure Co is 201.9 μTm³/kg.

A hard metal for tools for cutting stone, concrete, and asphalt is disclosed, for example, in U.S. Pat. No. 4,859,543. This patent claims hard metals with a ratio between hardness (Y, Rockwell A) and Co content (X, weight %) in the range of X=4.2-12 and Y=91-0.62 X.

EP 1 205 569 A2 and EP 1 043 415 A2 concern hard metals for metal cutting having low carbon contents and low values of magnetic saturation. Both publications respectively describe hard metals that contain more than 1% by weight cubic carbide (TaC, TiC, and NbC). The use and the aforementioned minimum amount of these cubic carbides is mandatory for the use of the hard metals as metal cutting tools.

Hard metals for tools for the construction industry or mining industry, however, may not contain Ta, Ti, or Nb in such appreciable quantities because their cubic carbides have a negative effect on the fracture toughness of the WC—Co hard metals. The hard metals that are conventionally used in the mining industry are exclusively tungsten carbide cobalt alloys (H. Kolaska, “Pulvermetallurgie der Hartmetalle”, Hagen, 1992, page 15/3).

DE 198 10 533 A1 discloses hard metals for milling titanium and titanium alloys with a Co-containing binder having relatively low values of magnetic saturation. However, no significant strengthening of the binder is present.

Finally, U.S. Pat. No. 5,723,177 describes hard metals that contain 3 to 60 volume % of diamond grains with a coating of carbides, nitrides, and/or carbonitrides of the chemical elements of the groups IV, V, and VI of the periodic table. With this coating, the direct dissolution of the diamond grains in the liquid binder during sintering is prevented. However, the coating itself is relatively quickly dissolved in the liquid binder.

The invention has the object to provide a hard metal or a hard metal-equipped tool with improved properties and performance.

This object is solved by a hard metal having the features of claim 1, of claim 6 or claim 13 as well as a tool according to claim 28.

By lowering the magnetic saturation to the range claimed in claim 1, in the hard metals of the aforementioned kind, in particular, coarse-grain hard metals, an increase of the transverse rupture strength is achieved in contrast to conventional state of research. Despite the low carbon contents, no macro ranges of η-phases are formed in this connection. The performance improvement is effective in particular for hard metals with coercive field strength values of up to 9.5 kA/m, even more up to 8 kA/m, preferably however in the range of 1.6-6.4 kA/m. In this connection, the average grain size of WC is preferably to be selected from a range of 0.2 μm to 20 μm, even better from a range of 2 μm to 20 μm, and especially preferred from a range of 4 to 20 μm.

It is known that the state of the binder plays an important role in regard to the performance of coarse-grain hard metals. Even though in current research (J. Willbrand, U. Wieland, “Techn. Mitt. Krupp. Forsch.-Ber.”, 1975, volume 33, 1, pp. 41-44), the generally accepted view is that the WC concentration or W concentration in the binder cannot be higher than 20% by weight (approximately 9 atomic %), the Co can be significantly strengthened in the hard metal according to the invention by means of a high concentration of tungsten of 10 to 30 atomic % in the binder. The greatest value of the lattice constant described in the literature (H. Suzuki, H. Kubota, “Planseeberichte Pulvermetallurgie”, 1966, volume 14,2, pp. 96-109) for Co in WC—Co hard metals is usually not higher than 0.357 nm (approximately 1% higher than the value of pure Co). In the hard metal according to the invention, the lattice constant of cobalt in the binder is however greater by 1 to 5% than that of pure cobalt (0.3545 nm) due to the higher concentration of tungsten.

It was found that for reaching the preferred properties in hard metals with relatively thin intermediate binder layers or high coercive field strength values of 17 kA/Nm up to 30 kA/Nm, the W concentration in the binder must be even somewhat higher so that the binder of such hard metals is effectively strengthened. This means that the values of the magnetic saturation of such hard metals according to the invention are to be selected still lower than for especially coarse-grain hard metals, i.e., must be selected from the range claimed in claim 6.

The hard metal according to the invention can be even further strengthened in that in the binder nanoparticles (particles finer than 100 nm) of tungsten and cobalt and/or carbon are embedded in the Co matrix. In this way, in comparison to conventional hard metals, the wear resistance and transverse rupture strength of the hard metal is significantly increased. The transverse rupture strength of such hard metals is higher by up to 30% than that of conventional hard metals with similar WC grain size and the same Co contents.

When embedded nanoparticles in the binder in hard metals having a magnetic saturation within the range claimed in claims 1, 6, and 13 reach a magnitude of at least 5 volume % of the binder, an entirely unexpected number of mechanical properties such as hardness, fracture toughness, breaking strength are significantly greater in comparison to those of conventional hard metals and, in particular, are independent, against all expectations, of the coercive field strength values. This holds true for coarse-grain as well as for fine-grain hard metals and even for such metals that are used for cutting metals.

A hard metal according to the invention that contains at least 5 volume % nanoparticles in the binder can contain preferably up to 40% by weight carbides, nitrides, and/or carbonitrides of Ta, Nb, Ti, V, Cr, Mo, B, Zr, and/or Hf.

Preferably, the nanoparticles in this connection also contain Ni, Fe, Ta, Nb, Ti, V, Cr, Mo, Zr, and/or Hf. The nanoparticles that are coherent with the cobalt matrix provide for a stabilization of the binder and thus also provide for the already described improvements of the hard metals properties as well as of a tool provided therewith.

Advantageously, the nanoparticles exhibit a hexagon or cubic lattice structure wherein the nanoparticles are comprised of one or several of the phases CoₓW_{y}C_{z} with values of X of 1 to 7, Y of 1 to 10, and Z of 0 to 4. In particular, the nanoparticles can be comprised of a phase Co₂W₄C. It is also possible that the nanoparticles are comprised of one or several intermetallic phases of tungsten and cobalt and, in this way, contribute to a further improvement of the binder in the sense of the aforementioned object.

The binder can be further strengthened when it contains fcc-Co and/or hcp-Co in the form of a solid solution of the W and/or C in Co. The lattice constants of this solid solution are by order of magnitude of 1 to 5% greater than that of pure Co.

Also, the binder can contain furthermore up to 30% by weight of iron.

The hard metals according to the invention with low carbon contents and high concentration of W in the binder contain also partially or entirely round WC grains; this has a very positive effect on the service life. The term round WC grains is meant to include not only round circular shapes but even usually irregular grain shapes with rounded corners without sharp facets.

Also, proportions of up to 1.5% by weight, respectively, of Cr, No, V, Zr, and/or Hf in the form of carbides and/or solid solutions in the binder lead to an improved service life.

By employing coated diamond grains, the hard metals according to the invention with high W contents in the binder can effect a significant performance improvement in the group of the ultra-hard hard-metal materials and can be used successfully because the combination of the high tungsten concentration in the binder with low magnetic saturation significantly suppresses a dissolution process of the coating of the diamond grains. According to an advantageous configuration of the invention, the hard metal contains 3% by volume up to 60% by volume diamond grains in a coating of carbides, carbonitrides, and/or nitrides of Ti, Ta, Nb, W, Co, Mo, V, Zr, Hf and/or Si.

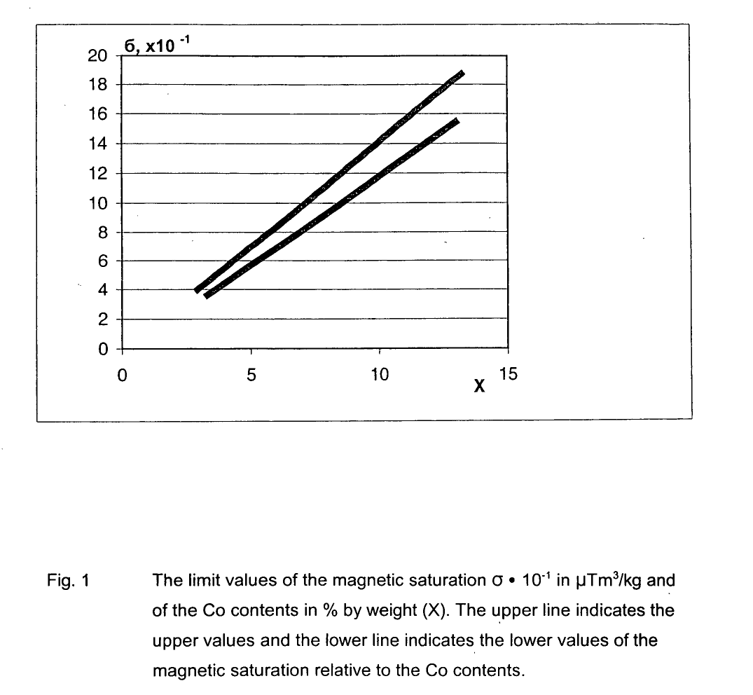

Further advantages and details are explained in more detail with aid of the following examples 1 to 4 and FIGS. 1 to 4.

FIG. 1 shows the limit values of the magnetic saturation for the range defined in claims 1 and 13.

### EXAMPLE 1

A WC—Co hard metal having a 6.5% by weight content of Co and a low carbon content was produced. The coercive field strength of this hard metal is 7.0 kA/m, the magnetic saturation is σ=0.8 μTm³/kg and 4πσ=10.0 μTm³/kg, the hardness is HV30 =1,100, the transverse rupture strength is 2,400 MPa. In the macro range (light-optical microscope), it can be seen that the hard metal has round WC grains, Co binder, and no η-phase. For examination by TEM (transmission electron microscope) a thin film sample was produced. The W concentration in the binder was determined on the sample with EDX (energy dispersive X-ray microanalysis). The Co lattice constant was determined by TEM and X-ray examinations.

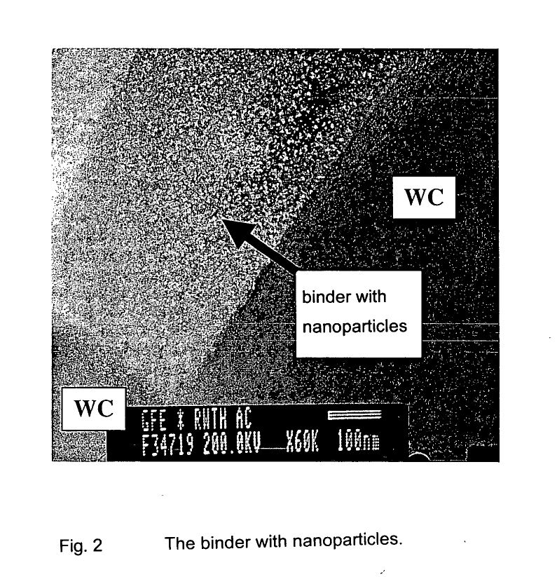

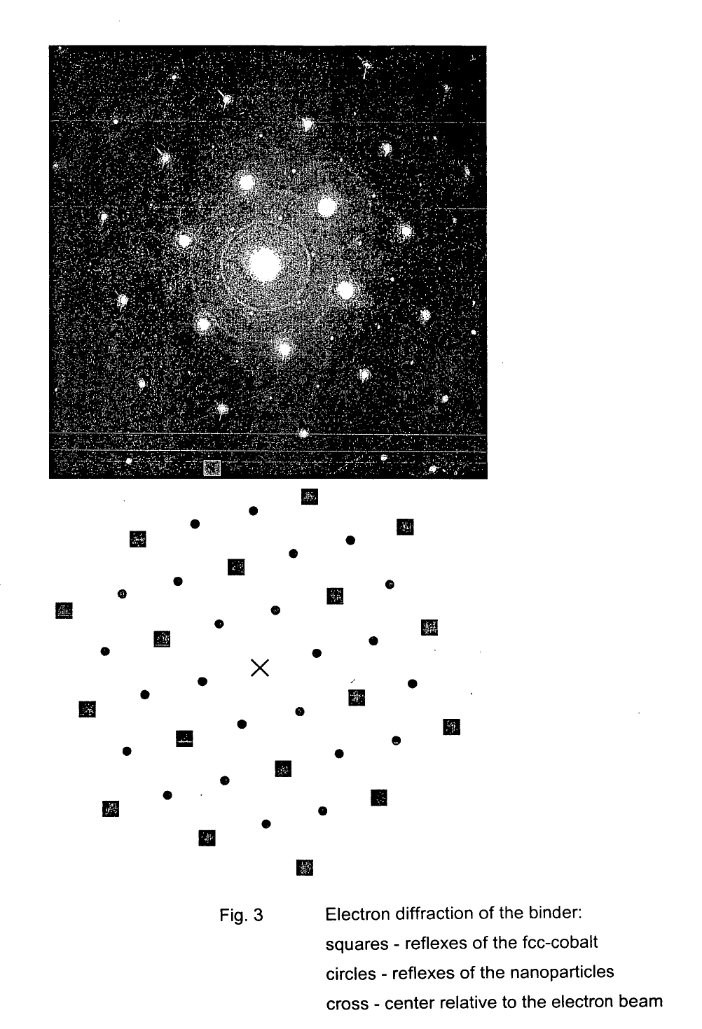

The W concentration in the binder of the sample is 18 to 19 atomic % and the binder contains nanoparticles as illustrated in FIG. 2. The electron diffractions of the binder show reflexes of the tungsten-containing cubic cobalt matrix with fcc structure and the lattice constant of 0.366 nm as well as reflexes of the nanoparticles positioned inbetween which are approximately 3 to 10 nm in size (FIG. 3). The greatest measurable Dₕₖₗ value of the nanoparticles (electron diffraction pattern with zone axis orientation of the cobalt matrix along [111]) is 0.215 nm.

As a reference, a conventional hard metal with 6.5% Co and normal carbon contents was produced. The coercive field strength of the reference hard metal is 6.4 kA/m, the magnetic saturation is σ=0.95 μTm³/kg and 4πσ=11.9 μTm³/kg, the hardness is HV30=1,140, the transverse rupture strength is 1,950 MPa. Road construction chisels with cutting elements of both hard metals were produced and tested on breaker hammers.

Wear-intensive asphalt was milled, on average 20 cm above concrete layer, with 10 m feed per minute on average. One half of the milling device was provided with chisels of the new hard metal and the other half with chisels of the conventional hard metal.

Results of the first field test:

| | | proportion of the chisels not | |
|---|---|---|---|
| | wear of the chisels that | carrying out rotation (possible | |
| hard metal | carry out rotation, in mm | breakage) and wear, in mm | |
| conventional | 6.9 | 30% | 8.6 |
| new | 3.4 | 6% | 3.8 |

The results of the first field test show that the improvement of the wear resistance of the new hard metal is approximately 50%. Of the chisels that did not carry out rotation, the proportion of chisels with the new hard metal is significantly lower than for conventional hard metal. This indicates that in the case of the new hard metal significantly fewer breakage incidents and/or destructive wear during cutting occurs.

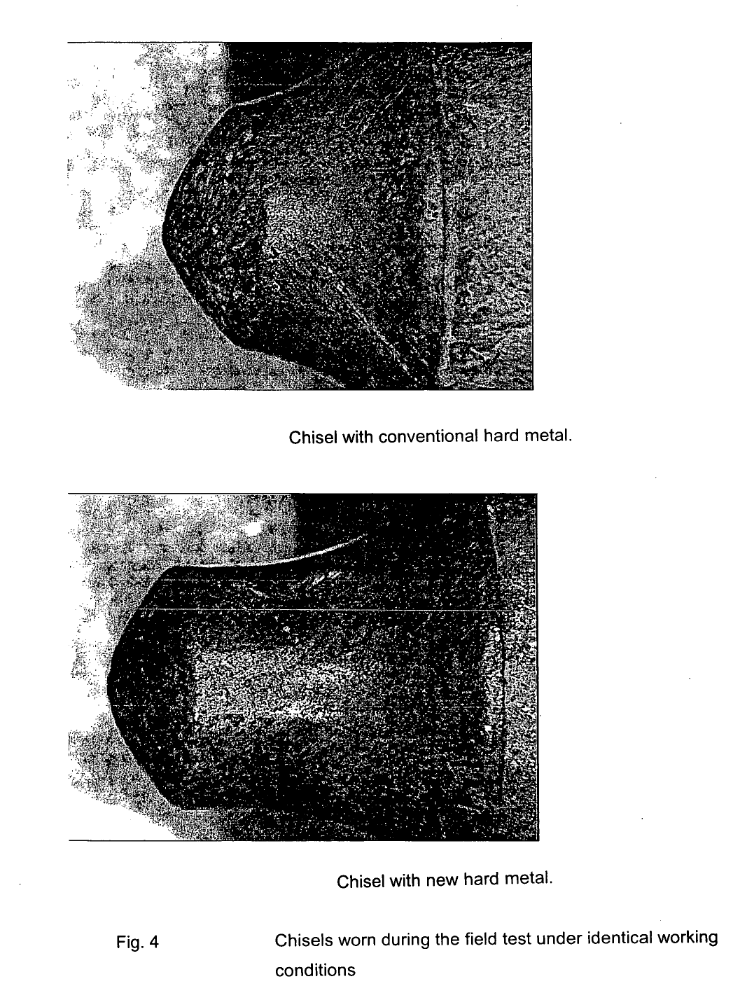

FIG. 4 shows a comparison of the worn chisels after the field test.

### EXAMPLE 2

Chisels with cutting elements of the hard metal of example 1 were investigated for milling cement of an average thickness of 30 cm and with, on average, 8 m feed per minute.

Results of the second field test:

| hard metal | wear, in mm | proportion of broken chisels |
|---|---|---|
| conventional | 9.7 | 13.6% |
| new | 2.8 | 2.4% |

The results of the second field test show that the wear resistance of the new hard metal is approximately three times higher than that of the conventional one. The fracture toughness of the new hard metal is also significantly improved in comparison to that of the conventional one. After the second field test it was found that the cutting elements of the new hard metal as well as of the conventional hard metal had thermal cracks (so-called “snake skin”). The cracks in the cutting elements made of the new hard metal however were significantly smaller and shorter than those in the conventional hard metal.

### EXAMPLE 3

A WC—Co hard metal containing by 9.5% by weight of Co and having a low carbon contents was produced. The coercive field strength is 6.1 kA/m, the magnetic saturation is σ=1.18 μTm³/kg and 4πσ=14.8 μTm³/kg, the hardness is HV30=990, the transverse rupture strength is 2,720 MPa. In the macro range the hard metal contains round WC grains, Co binder, and no η-phase.

As a reference material, a conventional hard metal with 9.5% Co and a normal carbon contents was produced. The coercive field strength is 4.3 kA/m, the magnetic saturation is σ=1.42 μTm³/kg and 4πσ=17.8 μTm³/kg, the hardness is HV30=1,020, the transverse rupture strength is 2,010 MPa.

The TEM examinations of the new hard metal show that the W concentration in the binder is 19 to 21 atomic % and that the binder contains nanoparticles. The lattice constant of fcc-Co in the binder is 0.368 nm.

Chisels with cutting elements of the two hard metals were produced and tested in the laboratory in regard to cutting abrasive concrete and granite. The chisels were also tested in a coal mine for cutting coal/sandstone having a high sandstone contents. With the chisels with cutting elements made of the new hard metal, cutting speeds of 700 m of concrete up to a wear of 1 mm were obtained while in the case of the chisels made of conventional hard metal the cutting performance was only 100 m for the same wear. The service life of the chisels when cutting granite with the new hard metal was approximately 2.5 times longer than that of the chisels with conventional hard metal.

In the third field test, two cutting heads were equipped with the cutting elements of the two hard metals. The two cutting heads with the chisels with the new hard metal obtained a cutting efficiency of 3000 m³ coal/sandstone. They exceeded thus the cutting performance of cutting heads of the chisel with conventional hard metal by about a factor of two. The field test showed also that in the new hard metal significantly fewer thermal cracks were formed than in the conventional hard metal.

### EXAMPLE 4

A WC—Co hard metal having a 6.5% by weight contents of Co and a low carbon contents was produced. The coercive field strength of this hard metal is 31.2 kA/m, the magnetic saturation is σ=0.75 μTm³/kg and 4πσ=9.4 μTm³/kg, the hardness is HV30=2,020, the transverse rupture strength is 2,900 MPa, and the fracture toughness is K_{1c}=12.4 MPam^{1/2} . The W concentration in the binder of the sample was 17 to 18 atomic % and the binder contains nanoparticles embedded in fcc-Co. The concentration of nanoparticles in the binderwas determined by the intercepting segment method. The concentration of nano particles is 7.0±0.5% by volume. As a reference, a conventional hard metal without nanoparticles and 6.5% Co and normal carbon contents was produced. The coercive field strength of the reference hard metal is 31.0 kA/m, the magnetic saturation is σ=0.97 μTm³/kg and 4πσ=12.2 μTm³/kg, the hardness is HV30=1,810, the transverse rupture strength is 1,900 MPa, and the fracture toughness is K_{1c}=9.3 MPam^{1/2}. Accordingly, in this case, the new hard metal also has, in evidence, an improved combination of hardness, transverse rupture strength, and fracture toughness.

According to the invention, based on the performed tests, hard metals are preferred whose Dₕₖₗ value of the ordered phases is up to 0.215 nm±0.007 nm.

As a result of the above described binder, the hard metals according to the present invention with coarse grain microstructure have an improved transverse rupture strength, fracture toughness, and wear resistance. Tools equipped with these hard metals have therefore a very high perfomance in the field of stone and asphalt cutting and, as wear parts, have a significantly increased service life.

What is claimed is:

1-29. (canceled)

30. A hard metal of WC for tools for mechanical working of stone, concrete, and asphalt, comprising:
5 to 25% by weight of a binder based on Co or Co and Ni;
wherein the hard metal has a coercive field strength up to 17.0 kA/m;
wherein the binder contains up to 30% of Fe;
wherein the hard metal has a magnetic saturation (σ or 4πσ, in units of microtesla times cubic meter per kilogram, respectively) as a function of the Co proportion (X) in % by weight of the hard metal in a range of
σ=0.11 X to σ=0.137X or
4πσ=0.44π X to 4πσ=0.548π X.

31. The hard metal according to claim 30, wherein the coercive field strength is maximally 9.5 kA/m.

32. The hard metal according to claim 30, wherein the coercive field strength is maximally 8.0 kA/m.

33. The hard metal according to claim 30, wherein the coercive field strength is maximally 7.2 kA/m.

34. The hard metal according to claim 30, wherein the coercive field strength is within a range of 1.6 kA/m to 6.4 kA/m.

35. The hard metal according to claim 30, wherein the binder contains nanoparticles of ordered phases of W, Co, and/or C.

36. The hard metal according to claim 35, wherein the nanoparticles are coherent with a cobalt matrix of the binder.

37. The hard metal according to claim 35, wherein the greatest measurable Dhkl value of the ordered phases of the nanoparticles is 0.215 nm±0.007 nm.

38. The hard metal according to claim 35, wherein at least parts of the nanoparticles have a hexagonal lattice structure or a cubic lattice structure.

39. The hard metal according to claim 35, wherein the nanoparticles are comprised of one or several of the phases CoₓW_{y}C_{z} with x=1 to 7, y=1 to 10, and z=0 to 4.

40. The hard metal according to claim 35, wherein the nanoparticles are comprised of a phase Co₂W₄C.

41. The hard metal according to claim 35, wherein the nanoparticles are comprised of one or several intermetallic phases of W and Co.

42. The hard metal according to claim 30, wherein the WC grains are partially or entirely round.

43. The hard metal according to claim 30, wherein the W concentration in the binder is in a range of 10 to 30 atomic %.

44. The hard metal according to claim 30, containing 3 to 60% by volume diamond grains with a coating of carbides, carbonitrides, and/or nitrides of at least one of Ti, Ta, Nb, W, Cr, Mo, V, Zr, Hf, and Si.

45. The hard metal according to claim 30, wherein the binder contains at least one of fcc-Co and hcp-Co in the form of a solid solution of at least one of W and C in Co.

46. The hard metal according to claim 30, wherein the lattice constants of the solid solution is 1% to 5% greater than that of pure Co.

47. The hard metal according to claim 36, wherein an average grain size of WC is within a range of 0.2 μm to 20 μm.

48. The hard metal according to claim 36, wherein an average grain size of WC is within a range of 2 μm to 20 μm.

49. The hard metal according to claim 36, wherein an average grain size of WC is within a range of 4 μm to 20 μm.

50. The hard metal according to claim 36, wherein the binder contains up to a total of 0.4% by weight of at least one of Ta, Nb, and Ti in the form of cubic carbides, solid solution, or carbides and solid solution.

51. The hard metal according to claim 36, wherein the binder contains up to, respectively, 1.5% by weight of at least one of Cr, Mo, V, Zr, and Hf in the form of carbides, solid solutions; or carbides and solid solutions.

52. A hard metal of WC for tools for mechanical working of stone, concrete, and asphalt, comprising:
5 to 25% by weight of a binder based on Co or Co and Ni;
wherein the binder contains nanoparticles of ordered phases of W, Co, and/or C;
wherein the hard metal has a coercive field strength above 17.0 kA/m and up to 30.0 kA/m;
wherein the hard metal has a magnetic saturation (σ or 4πσ, in units of microtesla times cubic meter per kilogram, respectively) as a function of the Co proportion (X) in % by weight of the hard metal in a range of
σ=0.11 X to σ=0.130 X or
4πσ=0.44π X to 4πσ=0.520π X.

53. The hard metal according to claim 52, wherein an average grain size of WC is within a range of 0.2 μm to 20 μm.

54. The hard metal according to claim 52, wherein an average grain size of WC is within a range of 2 μm to 20 μm.

55. The hard metal according to claim 52, wherein an average grain size of WC is within a range of 4 μm to 20 μm.

56. The hard metal according to claim 52, wherein the binder contains up to a total of 0.4% by weight of at least one of Ta, Nb, and Ti in the form of cubic carbides, solid solution, or carbides and solid solution.

57. The hard metal according to claim 52, wherein the binder contains up to, respectively, 1.5% by weight of at least one of Cr, Mo, V, Zr, and Hf in the form of carbides, solid solutions; or carbides and solid solutions.

58. The hard metal according to claim 52, wherein the nanoparticles are coherent with cobalt matrix of the binder.

59. The hard metal according to claim 52, wherein the nanoparticles are coherent with cobalt matrix of the binder.

60. The hard metal according to claim 52, wherein the greatest measurable DhkI value of the ordered phases of the nanoparticles is 0.215 nm±0.007 nm.

61. The hard metal according to claim 52, wherein at least parts of the nanoparticles have a hexagonal lattice structure or a cubic lattice structure.

62. The hard metal according to claim 52, wherein the nanoparticles are comprised of one or several of the phases CoₓW_{y}C_{z} with x=1 to 7, y=1 to 10, and z=0 to 4.

63. The hard metal according to claim 63, wherein the nanoparticles are comprised of a phase CO₂W₄C.

64. The hard metal according to claim 52, wherein the nanoparticles are comprised of one or several intermetallic phases of W and Co.

65. The hard metal according to claim 52, wherein the binder contains up to 30% by weight of Fe.

66. The hard metal according to claim 52, wherein the WC grains are partially or entirely round.

67. The hard metal according to claim 52, wherein the W concentration in the binder is in a range of 10 to 30 atomic %.

68. The hard metal according to claim 52, containing 3 to 60% by volume diamond grains with a coating of carbides, carbonitrides, and/or nitrides of at least one of Ti, Ta, Nb, W, Cr, Mo, V, Zr, Hf, and Si.

69. The hard metal according to claim 52, wherein the binder contains at least one of fcc-Co and hcp-Co in the form of a solid solution of at least one of W and C in Co.

70. The hard metal according to claim 52, wherein the lattice constants of the solid solution is 1% to 5% greater than that of pure Co.

71. A hard metal of WC comprising:
5 to 25% by weight of a binder based on Co or Co and Ni;
wherein the binder contains at least 5% by volume nanoparticles of ordered phases of W, Co, and/or C;
wherein the hard metal has a magnetic saturation (σ or 4πσ, in units of microtesla times cubic meter per kilogram, respectively) as a function of the Co proportion (X) in % by weight of the hard metal in a range of
σ=0.11 X to σ=0.137X or
4πσ=0.44π X to 4πσ=0.548π X.

72. The hard metal according to claim 71, containing up to 40% byweight carbides, nitrides, and/or carbonitrides of at least one of Ta, Nb, Ti, V, Cr, Mo, B, Zr, and Hf.

73. The hard metal according to claim 71, wherein the nanoparticles contain at least one of Ni, Fe, Ta, Nb, Ti, Cr, Mo, Zr, and Hf.

74. The hard metal according to claim 71, wherein the nanoparticles are coherent with cobalt matrix of the binder.

75. The hard metal according to claim 71, wherein the greatest measurable Dₕₖₗ value of the ordered phases of the nanoparticles is 0.215 nm±0.007 nm.

76. The hard metal according to claim 71, wherein at least parts of the nanoparticles have a hexagonal lattice structure or a cubic lattice structure.

77. The hard metal according to claim 71, wherein the nanoparticles are comprised of one or several of the phases CoₓW_{y}C_{z} with x=1 to 7, y=1 to 10, and z=0 to 4.

78. The hard metal according to claim 71, wherein the nanoparticles are comprised of a phase CO₂W₄C.

79. The hard metal according to claim 71, wherein the nanoparticles are comprised of one or several intermetallic phases of W and Co.

80. The hard metal according to claim 71, wherein the binder contains up to 30% by weight of Fe.

81. The hard metal according to claim 71, wherein the WC grains are partially or entirely round.

82. The hard metal according to claim 71, wherein the W concentration in the binder is in a range of 10 to 30 atomic %.

83. The hard metal according to claim 71, containing 3 to 60% by volume diamond grains with a coating of carbides, carbonitrides, and/or nitrides of at least one of Ti, Ta, Nb, W, Cr, Mo, V, Zr, Hf, and Si.

84. The hard metal according to claim 71, wherein the binder contains at least one of fcc-Co and hcp-Co in the form of a solid solution of at least one of W and C in Co.

85. The hard metal according to claim 71, wherein the lattice constants of the solid solution is 1% to 5% greater than that of pure Co.

86. A tool for mechanically working stone, concrete, and asphalt, comprising at least one cutting element, wherein the cutting element is comprised of a hard metal according to claim 30.

87. A tool for mechanically working stone, concrete, and asphalt, comprising at least one cutting element, wherein the cutting element is comprised of a hard metal according to claim 52.

88. A tool for mechanically working stone, concrete, and asphalt, comprising at least one cutting element, wherein the cutting element is comprised of a hard metal according to claim 71.
